(19) United States
(12) Patent Application Publication
(10) Pub. No.: US 2016/0127860 A1
(43) Pub. Date: May 5, 2016

(54) Communication System Equipped with a Radio Beacon

(71) Applicant: JCDecaux SA, Neuilly Sur Seine (FR)

(72) Inventor: Eric Penot, Le Pecq (FR)

(21) Appl. No.: 14/931,475

(22) Filed: Nov. 3, 2015

(30) Foreign Application Priority Data
Nov. 5, 2014 (FR) 1460698

(51) Int. Cl. H04W 4/00; H04L 29/06; H04W 12/08

(52) U.S. Cl. CPC H04W 4/008; H04W 12/08; H04L 63/083

(57) ABSTRACT

A communication system comprising: a radio beacon suitable for sending identification messages to a personal electronic device; and a control unit suitable for controlling the radio beacon and for modifying at predetermined time intervals, the identification messages sent by the radio beacon.

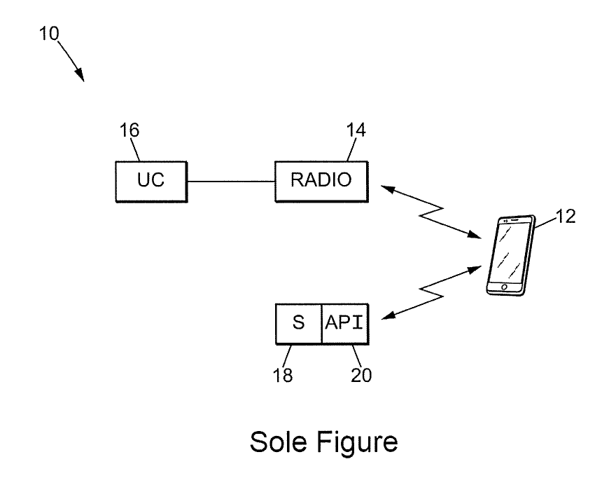

### FIELD OF THE INVENTION

The present invention concerns communication systems.

More particularly, the invention relates to a system of communication between a radio beacon and a personal electronic device of a user.

### BACKGROUND OF THE INVENTION

Such communication systems are known and are used in particular to transmit data of various types to the user.

### OBJECTS OF THE INVENTION

The present invention aims to improve such communication systems, particularly in order to increase their security.

For this purpose, a communication system of the type in question is characterized in that it comprises:
a radio beacon suitable for sending identification messages to a personal electronic device of a user; and
a control unit suitable for controlling the radio beacon and for modifying, at predefined time intervals, the identification messages sent by the radio beacon.

With these arrangements, the identification messages are modified dynamically and are only usable when authorized, thereby improving system security.

In various embodiments of the communication system of the invention, one or more of the following arrangements may possibly be used:
the control unit is adapted to modify, every 24 hours, the identification messages sent by the radio beacon;
the communication system further comprises a central server adapted to communicate with the personal electronic device in order to identify the identification messages sent by the radio beacon and received by the personal electronic device;
the central server is adapted to communicate with the personal electronic device every 24 hours;
the radio beacon is adapted to send the identification messages on its own initiative;
the radio beacon is a Bluetooth Low Energy beacon; and
the radio beacon has a range less than or equal to 60 m.

The invention also concerns a method of communication, characterized in that it comprises the following steps:
providing a communication system as described above and a personal electronic device of a user;
sending identification messages to the personal electronic device; and
modifying at predetermined time intervals, the identification messages sent by the radio beacon.

In various embodiments of the method according to the invention, one or more of the following arrangements may possibly be used:
one modifies every 24 hours, the identification messages sent by the radio beacon;
the identification messages are communicated to the personal electronic device in order to identify said identification messages after said identification messages have been received by the personal electronic device;
the identification messages are communicated to the personal electronic device every 24 hours;
the identification messages are communicated by a programming interface of a central server to at least one application installed on the personal electronic device;
the communication of identification messages is secured with an identifier and password;
the method further comprises a notification step during which, after an identification message has been received by the personal electronic device and identified, the personal electronic device is notified of data relating to the radio beacon; and
the personal electronic device is selected from among a smartphone, a smartpad, a smartwatch, and a personal digital assistant.

### BRIEF DESCRIPTION OF DRAWING

The invention will be better understood by reading the following description of one of its embodiments, given purely by way of non-limiting example and with reference to the sole accompanying FIGURE which is a block diagram illustrating the main electrical components of a communication system according to the invention.

### DETAILED DESCRIPTION

The sole FIGURE illustrates a communication system 10 suitable for communicating with a personal electronic device 12 of a user, such as a smartphone, a tablet or smartpad, a smartwatch or computerized wristwatch, a personal digital assistant or PDA, etc.

In the embodiment described here, the personal electronic device 12 is a smartphone.

The communication system 10 comprises a radio beacon 14 (RADIO) and a control unit 16 (UC).

The radio beacon 14 is adapted to send identification messages to the smartphone 12.

In particular, the radio beacon 14 is adapted to send the identification messages on its own initiative.

The sending of identification messages may, for example, occur continuously or at regular intervals.

The radio beacon 14 is preferably a smart beacon.

Advantageously, the radio beacon 14 is preferably a Bluetooth Low Energy (BLE) beacon.

The radio beacon 14 is preferably a medium-range beacon and may have a range, for example, of less than or equal to 60 m.

The control unit 16 is suitable for controlling the radio beacon 14.

In particular, the control unit 16 is adapted to control the radio beacon 14 and to modify the identification messages sent by the radio beacon 14 at predetermined time intervals.

For example, the control unit 16 can be adapted to modify the identification messages sent by the radio beacon 14 every 24 hours.

Alternatively, the control unit 16 can be adapted to modify the identification messages sent by the radio beacon 14 every hour, every minute, etc.

The control unit 16 is, for example, a microprocessor, microcontroller, or the like.

To enable the smartphone 12 to identify the identification messages it receives from the radio beacon 14, the communication system 10 further comprises a central server 18 (S) suitable for communicating to the smartphone 12 the identification messages that are to be sent by the radio beacon 14.

The communication of identification messages between the smartphone 12 and the central server 18 is implemented via applications installed on the smartphone 12 and by a programming interface 20 (API) of the central server 18.

This communication is secured with an application-specific identifier and password.

The programming interface 20 thus provides a service on the central server 18 that is usable by applications installed on the smartphone 12, via the identifier and password, for recognizing the identification messages sent by the radio beacon 14 and received by the smartphone 12.

Advantageously, if the identification messages are modified every 24 hours, communication between the central server 18 and the smartphone 12 also takes place every 24 hours.

Advantageously, this communication takes place prior to the sending of the identification messages by the radio beacon 14.

Advantageously, this communication takes place simultaneously with the modification of the identification messages.

An identification message sent by the radio beacon 14 and received by the smartphone 12 is therefore only identifiable if the programming interface 20 of the central server 18 has communicated this identification message in advance to at least one application installed on the smartphone 12.

This prevents identification messages from the radio beacon being decoded by other users and therefore this radio beacon from being used by other users.

When an identification message sent by the radio beacon 14 is received by the smartphone 12 and recognized, the application can notify the user of data relating to the radio beacon 14.

These data may include an image, a video, a sound, an application, practical information, a link to an online payment page, etc.

The invention therefore provides a communication system that allows controlling access to the radio beacon and measuring the use of this radio beacon.

In addition, the use of a beacon and of Bluetooth Low Energy (BLE) enables implementation of a simple, fast, robust, inexpensive, and energy efficient system that is compatible with most personal electronic devices.

1. A communication system comprising:
a radio beacon suitable for sending identification messages to a personal electronic device of a user; and
a control unit suitable for controlling the radio beacon and for modifying, at predetermined time intervals, the identification messages sent by the radio beacon.

2. The communication system according to claim 1, wherein the control unit is adapted to modify, every 24 hours, the identification messages sent by the radio beacon.

3. The communication system according to claim 1, further comprising a central server adapted to communicate with the personal electronic device in order to identify the identification messages sent by the radio beacon and received by the personal electronic device.

4. The communication system according to claim 3, wherein the control unit is adapted to modify, every 24 hours, the identification messages sent by the radio beacon and wherein the central server is adapted to communicate with the personal electronic device every 24 hours.

5. The communication system according to claim 1, wherein the radio beacon is adapted to send the identification messages on its own initiative.

6. The communication system according to claim 1, wherein the radio beacon is a Bluetooth Low Energy beacon.

7. The communication system according to claim 1, wherein the radio beacon has a range less than or equal to 60 m.

8. A method of communication comprising the following steps:
providing a communication system according to claim 1 and a personal electronic device;
sending identification messages to the personal electronic device; and
modifying at predefined time intervals, the identification messages sent by the radio beacon.

9. The method according to claim 8, wherein one modifies every 24 hours the identification messages sent by the radio beacon.

10. The method according to claim 8, wherein the identification messages are communicated to the personal electronic device in order to identify said identification messages after said identification messages have been received by the personal electronic device.

11. The method according to claim 10, wherein one modifies every 24 hours the identification messages sent by the radio beacon and wherein the identification messages are communicated to the personal electronic device every 24 hours.

12. The method according to claim 10, wherein the identification messages are communicated by a programming interface of a central server to at least one application installed on the personal electronic device.

13. The method according to claim 10, wherein the communication of identification messages is secured with an identifier and password.

14. The method according to claim 10, further comprising a notification step during which, after an identification message has been received by the personal electronic device and identified, the personal electronic device is notified of data relating to the radio beacon.

15. The method according to claim 8, wherein the personal electronic device is selected from among a smartphone, a smartpad, a smartwatch, and a personal digital assistant.
